(19) United States
(12) Patent Application Publication
(10) Pub. No.: US 2008/0027833 A1
(43) Pub. Date: Jan. 31, 2008

(54) Method for optimizing sample size for inventory management processes

(75) Inventor: Gerald Lee Myers, Heyworth, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/495,522

(22) Filed: Jul. 31, 2006

(51) Int. Cl. G06Q 10/00

(52) U.S. Cl. 705/28

(57) ABSTRACT

A method for determining a sample size associated with inventory management processes comprises selecting a product population associated with a product inventory and grouping the product population into a plurality of strata. Each strata has a plurality of products, wherein each product includes at least one aspect common to each of the other products of the plurality of products. A sample size for each of the plurality of strata associated with a statistical test count process is determined based on a predetermined criteria. The method also includes performing a statistical test count of each strata, based on the determined sample size, and determining an inventory error based on the statistical test count. The inventory error is compared with a predetermined error threshold. If the inventory error exceeds the predetermined error threshold, the predetermined criteria associated with the sample size is adjusted based on historical inventory error data. If the inventory error does not exceed the predetermined error threshold, an inventory record associated with the product inventory is updated.

### TECHNICAL FIELD

The present disclosure relates generally to inventory management systems and, more particularly, to methods for determining a sample size associated with inventory management processes.

### BACKGROUND

In many commercial enterprises, such as manufacturing, retail, and shipping, inventory management may be one of the most important operational challenges facing a business. For instance, commercial business environments, particularly those that rely on a large number of inventory transactions between suppliers, distributors, and customers, may implement certain inventory control procedures to monitor and record changes to an inventory population. In certain circumstances, inventory records may be verified and updated using actual inventory stock data. The actual stock data may be obtained by physically counting each item associated with the inventory population. This physical count process may be expansive, time consuming, and crippling to operations of the business.

In order to obtain actual inventory stock data without requiring a comprehensive physical count of each part in a product inventory, some businesses have developed statistical test count processes. These test count processes typically involve counting a characteristic subpopulation associated with the inventory population and extrapolating the data derived from the subpopulation count over the entire inventory population. However, because the subpopulation data is extrapolated across the inventory population, any error associated with the subpopulation count may be propagated across the entire inventory population. Errors associated with the subpopulation count typically stem from an inadequately sized-sample of counted items. However, selecting too large a sample, which may potentially increase count accuracy, may require large amounts of inventory management resources (such as personnel dedicated to performing the count). In order to solve this problem, an accurate method for determining a sample size associated with an inventory management process may be required.

One method for selecting samples associated with a subpopulation of inventory is described in U.S. Patent Application Publication No. 2003/0120563 (“the '563 publication”) to Meyer. The '563 publication describes a method of managing inventory that includes organizing the inventory using a classification program. Certain parts within the inventory may be randomly selected for inclusion in a population of inventory items to count. The results of the count of the population may be extrapolated across the total number of inventory items to count to modify an inventory record. Inventory items that adversely affect the overall results may be identified and flagged for further analysis.

Although the method described in the '563 publication may organize an inventory population and randomly select samples for inclusion in the population of inventory items to count, it may be inaccurate and inefficient. For instance, the method described in the '563 publication may only randomly select samples, without regard for the sample size or the number of counts to be performed on the selected inventory. In some cases, this random selection may not contain a statistically adequate cross-section of a population, potentially rendering any test count results unreliable and, potentially, inaccurate.

The presently disclosed system and method for managing inventory control processes are directed toward overcoming one or more of the problems set forth above.

### SUMMARY OF THE INVENTION

In accordance with one aspect, the present disclosure is directed toward a method for determining a sample size associated with inventory management processes. The method may include selecting a product population associated with a product inventory and grouping the product population into a plurality of strata. Each strata has a plurality of products, wherein each product includes at least one aspect common to each of the other products of the plurality of products. A sample size for each of the plurality of strata associated with a statistical test count process is determined based on a predetermined criteria. The method also includes performing a statistical test count of each strata, based on the determined sample size, and determining an inventory error based on the statistical test count. The inventory error is compared with a predetermined error threshold. If the inventory error exceeds the predetermined error threshold, the predetermined criteria associated with the sample size is adjusted based on historical inventory error data. If the inventory error does not exceed the predetermined error threshold, an inventory record associated with the product inventory may be updated.

According to another aspect, the present disclosure is directed toward a method for determining a sample size associated with inventory management processes. The method may include selecting a product population associated with a product inventory and grouping the product population into a plurality of strata. Each strata may include a plurality of products, wherein each product may include at least one aspect common to each of the other products of the plurality of products. The method may further include determining a sample size for each of the plurality of strata associated with a statistical test count process based on a desired confidence factor associated with the statistical test count. A number of counts to be performed for each strata may be determined based on the sample size and a percent value for each of the plurality of strata relative to a value of the product inventory.

In accordance with yet another aspect, the present disclosure may be directed toward a computer readable medium for use on a computer system, the computer readable medium including computer executable instructions for performing a method for determining a sample size for inventory management processes. The method may include selecting a product population associated with a product inventory and grouping the product population into a plurality of strata. Each strata has a plurality of products, wherein each product includes at least one aspect common to each of the other products of the plurality of products. A sample size for each of the plurality of strata associated with a statistical test count process is determined based on a predetermined criteria. The method also includes performing a statistical test count of each strata, based on the determined sample size, and determining an inventory error based on the statistical test count. The inventory error is compared with a predetermined error threshold. If the inventory error exceeds the predetermined error threshold, the predetermined criteria associated with the sample size is adjusted based on historical inventory error data. If the inventory error does not exceed the predetermined error threshold, an inventory record associated with the product inventory may be updated.

### BRIEF DESCRIPTION OF THE DRAWINGS

FIG. 1 illustrates an exemplary disclosed inventory environment consistent with certain disclosed embodiments;

FIG. 2 provides an exemplary disclosed stratification process for establishing a plurality of groups for a statistical test count process associated with an inventory control process; and

FIG. 3 provides an inventory process management systems consistent with certain disclosed embodiments.

### DETAILED DESCRIPTION

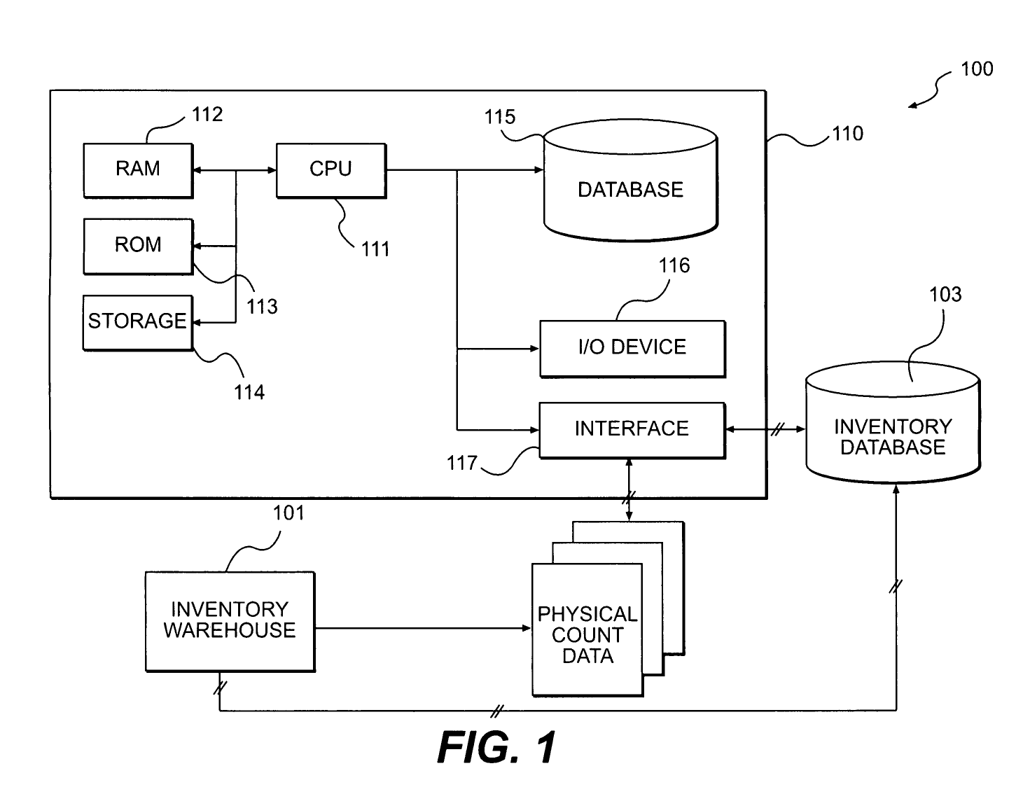

FIG. 1 provides a block diagram illustrating an exemplary disclosed inventory environment 100. Inventory environment may include any type of environment associated with monitoring and/or managing an inventory that includes a population of elements. For example, inventory environment 100 may include a product warehouse configured to receive and distribute large numbers of products for operating a business. Inventory environment 100 may include, among other things, an inventory warehouse 101 containing a plurality of products, an inventory database 103, and a system 110 for maintaining inventory records.

Inventory warehouse 101 may include any type of facility for storing a plurality of products. Products, as the term is used herein, may include any physical or virtual element that may be used as a product associated with a business. Non limiting examples of physical products may include machines or machine parts or accessories such as, for example, electronic hardware or software, work implements, traction devices such as tires, tracks, etc., transmissions, engine parts or accessories, fuel, or any other suitable type of physical product. Non limiting examples of virtual products may include inventory data, product documentation, software structures, software programs, financial data or documents such as stock records, or any other type of virtual product. Inventory warehouse 101 may include, for example, a parts depot, a product showroom, a document storage facility, or any other type of facility suitable for storing physical and/or virtual products.

Inventory database 103 may include any type of electronic data storage device that may store data information. Inventory database 103 may contain one or more inventory records associated with each of the plurality of products associated with inventory warehouse 101. Inventory database 103 may constitute a standalone computer system that includes one or more computer programs for monitoring and/or maintaining inventory records associated therewith. Alternatively and/or additionally, inventory database 103 may be integrated as part of an inventory warehouse computer or system 110 for maintaining inventory records. It is also contemplated that inventory database 103 may include a shared database between one or more computer systems of business entities associated with inventory warehouse 101, such as an accounting division, a sales division, a supplier, or any other appropriate business entity that may typically deal with an inventory warehouse.

System 110 may include any type of processor-based system on which processes and methods consistent with the disclosed embodiments may be implemented. For example, as illustrated in FIG. 1, system 110 may include one or more hardware and/or software components configured to execute software programs, such as software for managing inventory environment 100, inventory monitoring software, or inventory transaction software. For example, system 110 may include one or more hardware components such as, for example, a central processing unit (CPU) 111, a random access memory (RAM) module 112, a read-only memory (ROM) module 113, a storage 114, a database 115, one or more input/output (I/O) devices 116, and an interface 117. Alternatively and/or additionally, system 110 may include one or more software components such as, for example, a computer-readable medium including computer-executable instructions for performing methods consistent with certain disclosed embodiments. It is contemplated that one or more of the hardware components listed above may be implemented using software. For example, storage 114 may include a software partition associated with one or more other hardware components of system 110. System 110 may include additional, fewer, and/or different components than those listed above. It is understood that the components listed above are exemplary only and not intended to be limiting.

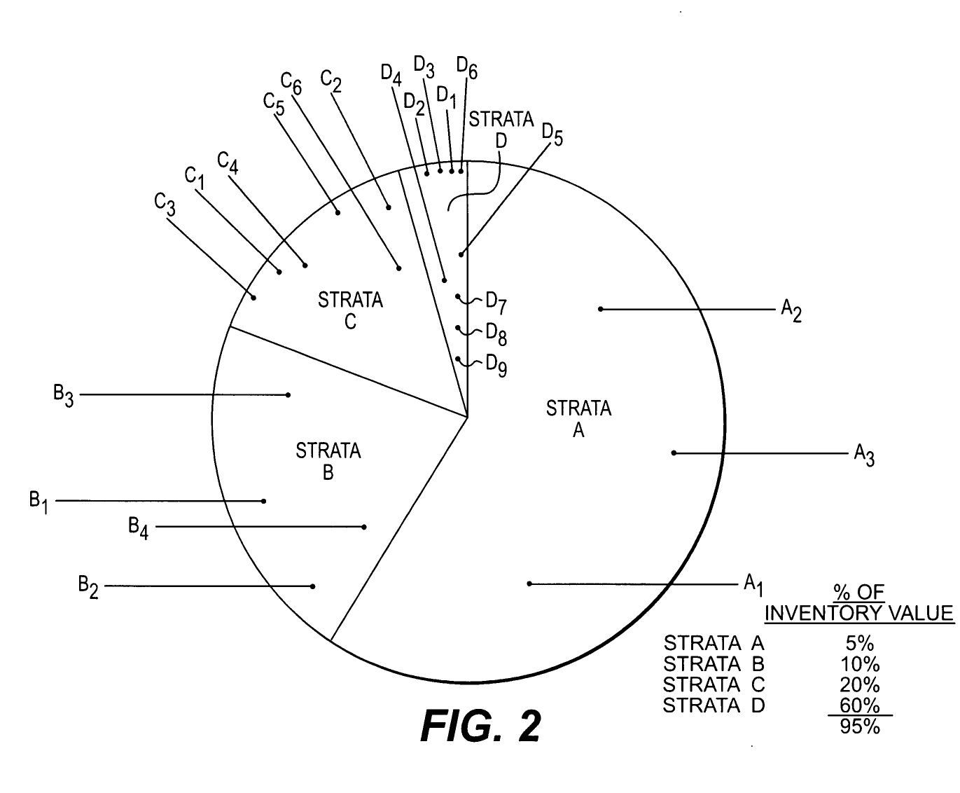

CPU 111 may include one or more processors, each configured to execute instructions and process data to perform one or more functions associated with system 110. As illustrated in FIG. 2, CPU 111 may be communicatively coupled to RAM 112, ROM 113, storage 114, database 115, I/O devices 116, and interface 117. CPU 111 may be configured to execute sequences of computer program instructions to perform various processes, which will be described in detail below. The computer program instructions may be loaded into RAM for execution by CPU 111.

RAM 112 and ROM 113 may each include one or more devices for storing information associated with an operation of system 110 and/or CPU 111. For example, ROM 113 may include a memory device configured to access and store information associated with system 110, including information for identifying, initializing, and monitoring the operation of one or more components and subsystems of system 110. RAM 112 may include a memory device for storing data associated with one or more operations of CPU 111. For example, ROM 113 may load instructions into RAM 112 for execution by CPU 111.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by system 110 and/or CPU 111. For example, database 115 may include historical data, such as previous adjustments to inventory records based on physical count data and/or previous inventory records. CPU 111 may access the information stored in database 115 for comparing the physical count data with the inventory record data to determine whether an adjustment to the inventory record may be required. CPU 111 may also analyze current and previous inventory count records to identify trends in inventory count adjustment. These trends may then be recorded and analyzed to adjust one or more aspects associated with an inventory control process, which may potentially reduce inventory management errors leading to product loss and/or inventory write-off. It is contemplated that database 115 may store additional and/or different information than that listed above.

I/O devices 116 may include one or more components configured to communicate information with a user associated with system 10. For example, I/O devices may include a console with an integrated keyboard and mouse to allow a user to input parameters associated with system 110. I/O devices 116 may also include a display including a graphical user interface (GUI) for outputting information on a monitor. I/O devices 116 may also include peripheral devices such as, for example, a printer for printing information associated with system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 117 may include one or more components configured to transmit and receive data via a communication network, such as the Internet, a local area network, a workstation peer-to-peer network, a direct link network, a wireless network, or any other suitable communication platform. For example, interface 117 may include one or more modulators, demodulators, multiplexers, demultiplexers, network communication devices, wireless devices, antennas, modems, and any other type of device configured to enable data communication via a communication network.

System 110 may be configured to perform certain tasks associated with a statistical test count process, to identify inventory error patterns associated with an inventory control process. These error patterns may assist inventory management personnel in diagnosing a source of error in the inventory management process and modify the process to substantially reduce or eliminate the error.

System 110 may be configured to divide (using a software stratification process) an inventory population into a plurality of subpopulations or groups, called strata, based on one or more predetermined criteria. Using this stratification method, a statistically robust sample may be selected such that any analysis based on the sample may be accurately and confidently extrapolated over the respective subpopulation and/or the entire inventory population.

According to one embodiment, for example, system 110 may execute stratification software that establishes a plurality of groups associated with an inventory population. The number of groups to be established by the stratification software may be predetermined or, alternatively, may be input by a user. Once a number of groups has been established, a stratification criteria may be selected. For purposes of the present disclosure, stratification criteria may include one or more characteristics, such as product price, size, type, storage characteristic (e.g., warehouse location, shelf number) or any other aspect that may be common to each product associated with a particular group. For example, stratification criteria may include a price range associated with each of the plurality of groups. As such, system 110 may consolidate products whose prices fall within a particular range into a common group.

FIG. 2 provides a chart that depicts an exemplary stratification process performed by system 110, in accordance with certain disclosed embodiments. As illustrated in FIG. 2, four different groups (strata) may be established by system 110 based on a percent value associated with each of a plurality of products. Each strata may be associated with a percentage of a total value of an entire of inventory of products. For example, strata A, containing a majority of the part numbers, may correspond to only 5% of the overall value of the inventory. On the other hand, strata D, containing a substantially smaller quantity of high-priced part numbers, may comprise 60% of the total value of the inventory.

Once the groups have been established, system 110 may randomly select one or more part numbers associated with each group. The number of part numbers selected (which corresponds to the sample size for the statistical test count process) may be determined based on one or more of the total number of parts in the strata.

Once the part numbers have been selected, a number of counts to be performed for each of the respective part numbers may be determined. The number of counts may be based on the value of the products in the strata associated with a particular part number relative to the overall value of the product inventory. For example, the number of counts to be performed may be determined by multiplying the number of part numbers selected from each group (or strata) by the percent value of the respective group relative to the overall value of the product inventory. As one skilled in the art will recognize, because all of the part numbers associated with strata “A” constitute only 5% of the overall value of the inventory, fewer part numbers may be required for auditing from the lower value strata in order to maintain an acceptable error threshold respective to the value of the entire inventory population. Conversely, more part numbers may be required for auditing from the higher value strata (e.g., strata “D”), as loss or error associated with a single product may significantly effect the overall error with respect to the total value of the inventory population.

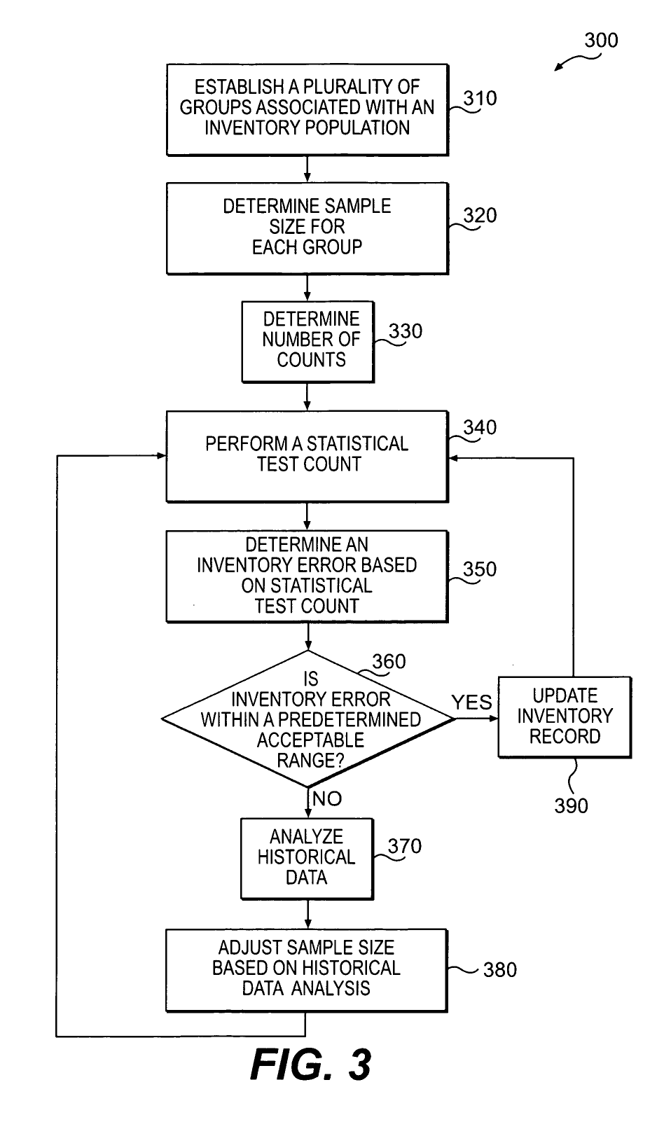

Processes and methods consistent with the disclosed embodiments may provide a method for determining an appropriate sample size associated with a statistical test count process to increase accuracy associated with a inventory management process. FIG. 3 provides a flowchart 300 depicting one such method. As illustrated in FIG. 3, a plurality of groups associated with an inventory population may be established (Step 310). For example, CPU 111 associated with system 110 may be configured to execute stratification software that automatically establishes a plurality of subpopulations from a larger inventory population, based on predetermined criteria and/or user input. For example, a user may select one or more of a number of subgroup divisions and/or a subgrouping criteria associated with a product population using a graphical user interface (GUI) associated with system 110. The stratification software may automatically sort an inventory population (which may be represented electronically in inventory database 103) based on the user inputs. According to one embodiment, the groups may be established using a stratification process, such as the one described in reference to FIG. 2. Alternatively, the groups may be arranged using any suitable automated or manual process based on at least one predetermined criteria, such that each product associated with each of the plurality of groups has at least one aspect in common.

Once a plurality of groups has been established a plurality of samples may be selected from each group (Step 320). The samples may be selected at random, using any suitable type of random sample selection device. According to one embodiment, CPU 111 may execute a random sample selection algorithm that selects one or more part numbers from among a plurality of part numbers stored in inventory database 103. Alternatively, one or more part numbers may be randomly selected manually, by inventory management personnel.

The number of part numbers selected for each group or subpopulation may be determined based on the size of the population associated with the group and/or the value of the group relative to the overall value of the entire inventory. The number of part numbers selected may be predetermined or, alternatively, may be identified using any suitable sample selection algorithm for determining an appropriate statistical sample for a population. For example, the number of part numbers may be determined based on one or more of a total number of elements in the population, an historical standard deviation data associated with inventory error, or a confidence factor that may be required in the statistical test count data. According to one embodiment, system 110 may determine the minimum sample size, n, based on the following formula:

$$n = {( \frac{x}{Δ} )}^{2} \cdot P ( 1 - P ) \qquad ( Eq . 1 )$$

where x is a predetermined constant corresponding to a confidence level which may be obtained from a table (e.g., x=1.96 for a confidence level of 95%); P corresponds to a desired confidence level (e.g., P=0.95 for a desired confidence level of 95%); and Δ includes an acceptable standard deviation for a particular sample or element. It should be noted that one or more of the variables noted above may be dependent on one or more other variables. For instance, as standard deviation decreases corresponding to a decrease in inventory error associated with the statistical test count, a confidence factor in the test count process may increase. Accordingly, once a desired standard deviation is reached, the sample size may be reduced based on a desired confidence factor associated with the test count process.

Once the number of samples (e.g., part numbers) has been selected, the number of physical counts to be performed for each part number may be determined (Step 330). The number of physical counts may be based on the sample size and the percent value associated with a particular strata respective of the value of the entire inventory. For example, CPU 111 may execute a count determination algorithm that calculates the number of counts using the expression:

y=n·v (Eq. 2)

where y is the number of counts to be performed; n is the minimum sample size which may be determined using Eq. 1; and v corresponds to the percent value of the particular strata relative to the value of the entire inventory.

A statistical test count may be performed based on the number of samples and the number of counts (Step 340). The statistical test count may include a physical count of each selected sample and may be repeated “y” times. Because the number of counts to be performed, y, is based on the confidence factor and historical accuracy of previous statistical test counts, those skilled in the art will recognize that the number of counts may be directly proportional to the desired confidence factor associated with the test count. The physical count portion of the statistical test count may be performed manually by one or more inventory management personnel. Alternatively, the physical count may include a semi-automated process whereby barcodes affixed to each product may be scanned using optical scanning devices or other handheld scanning instruments. The scanned data may be uploaded to system 110, which may automatically sort and count the scanned data to produce physical count data.

Once a physical count has been performed, an inventory error may be identified (Step 350). Inventory error, as the term is used herein, refers to an amount by which a physical count data differs from inventory record data for each of the plurality of selected part numbers. The inventory error may be reflected as a difference (e.g., deficit or surplus) between the actual quantity and the inventory record for a particular part number. For example, if the actual quantity of part number “X” determined by a physical count is 13 units, while the inventory record indicates that there are 15 units, the software may assign an inventory error of −2 to part number “X”. Alternatively, inventory error may be expressed as a variance, a standard deviation, or other suitable statistical representation indicative of a discrepancy between physical count data and data reflected in the inventory record. Although inventory error is described in connection with a quantity discrepancy between physical count data and inventory record data, it is contemplated that inventory error may also be expressed as a monetary value discrepancy.

The inventory error may be compared with a predetermined error range (Step 360). The predetermined error range may correspond to a range of inventory error that, when exceeded, may be indicative of inventory error that exceeds an acceptable range of fluctuation. If, upon comparison, the inventory error is within the predetermined error range (Step 360: Yes), the inventory error may be updated (Step 390), without requiring an inventory error analysis.

Alternatively, if the inventory error does not lie within the predetermined error range (Step 360: No), historical error data may be analyzed to determine a historical accuracy of the statistical test count process (Step 370). For example, system 110 may analyze historical statistical test count data to compare inventory error data, confidence factors, and sample sizes, to adjust a sample size associated with the inventory management process (Step 380). In one embodiment, system 110 may determine that previous statistical test counts were based on sample sizes determined with a 90% confidence factor. Over time, the cumulative historical accuracy declined until the inventory error exceeded the predetermined error range. As a result, system 110 may adjust the minimum sample size by adjusting a confidence factor associated with the sample size algorithm (i.e., Eg. 1) until the inventory error and/or cumulative historical data conforms to the predetermined error range.

According to one embodiment, the sample size may be reduced if the inventory error is less than a minimum threshold, in order to more efficiently manage the inventory control process. For example, for a particular product or strata, the minimum threshold may be set at 1% and the predetermined error threshold may be set at 3%. Upon performing a statistical test count process, if the inventory error exceeds the predetermined error threshold, than the sample size may be increased by increasing the desired confidence factor associated with Eq. 1. Alternatively, if the inventory error is less than 1%, indicating that the inventory error is more than acceptable, the sample size may be reduced by decreasing the desired confidence factor associated with Eq. 1. If the inventory error is between 1% and 3%, the statistical test count process is considered to be operating effectively, and no adjustments to the sample size may be required.

### INDUSTRIAL APPLICABILITY

Although methods consistent with the disclosed embodiments are described in relation to product warehouse environments, they may be applicable to any environment where management of tangible or intangible inventory may be required. According to one embodiment, the disclosed method for determining a sample size for inventory management processes may enable organizations that rely on statistical test count processes for inventory management to accurately determine and adjust a minimum sample size and number of counts to be performed by the statistical test count process. As a result, statistical test counts may be adjusted to comply with certain predetermined accuracy parameters to ensure that inventory is managed efficiently and accurately.

The presently disclosed method for determined a sample size for inventory management processes may have several advantages. For example, because the sample size and number of physical counts may be adjusted based on certain predetermined criteria, such as a value of items in a group, inventory error may be controlled based on a desired level of accuracy for a particular product population. As a result, groups containing expensive items may be more closely monitored, with less tolerance for error than groups containing a large number of inexpensive items. This accuracy adjustment capability may be particularly valuable in environments where inventory management resources may be limited, allowing inventory management personnel to focus on high-priority inventory items.

Furthermore, the presently disclosed system may provide businesses with more control over inventory management processes. For example, because sample sizes may be adjusted based on a desired confidence factor and historical data analysis, system 110 may enable users to adjust the accuracy of statistical test count results. Accordingly, the presently disclosed method may enable businesses to customize their inventory management processes depending upon the desired level of accuracy of the inventory management data.

By providing a minimum threshold, the inventory management process may effectively define an inventory management benchmark. This benchmark may ensure that the appropriate balance of inventory accuracy and time/resource management may be met. Accordingly, systems that provide a predetermined error threshold and a minimum threshold may enable the adjustment of sample size based, not only on minimizing inventory error, but on controlling inventory management resource and cost.

It will be apparent to those skilled in the art that various modifications and variations can be made to the disclosed method for determining sample size for inventory management processes. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for optimizing a sample size associated with an inventory management process, comprising:
determining a sample size for each of a plurality of strata associated with a statistical test count process based on a predetermined criteria, wherein each of the plurality of strata includes a subpopulation associated with a product inventory, each strata having a plurality of products, each product of the plurality of products including at least one aspect common to each of the other products of the plurality of products;
performing a statistical test count of each strata, based on the determined sample size;
determining an inventory error based on the statistical test count;
comparing the inventory error with a predetermined error threshold;
adjusting, based on historical inventory error data, the predetermined criteria associated with the sample size if the inventory error exceeds the predetermined error threshold; and
updating an inventory record associated with the product inventory if the inventory error does not exceed the predetermined error threshold.

2. The method of claim 1, wherein the predetermined criteria includes a desired confidence factor associated with the statistical test count.

3. The method of claim 2, wherein determining the sample size for each of the plurality of strata includes adjusting the desired confidence factor based on historical accuracy data associated with the statistical test count.

4. The method of claim 3, wherein the historical accuracy data includes a standard deviation associated with the performance of previous statistical test counts.

5. The method of claim 4, wherein determining the sample size for each of the plurality of strata includes estimating a minimum number of samples using the equation:
$$n = {( \frac{x}{Δ} )}^{2} \cdot P ( 1 - P )$$
where x is a predetermined constant corresponding to the desired confidence factor, P corresponds to the desired confidence factor, and Δ includes an average standard deviation based on historical statistical test count data.

6. The method of claim 1, wherein performing a statistical test count includes determining, based on the sample size, a number of physical counts to be performed as part of a statistical test count associated with each strata.

7. The method of claim 6, wherein determining the number of counts to be performed for each strata includes:
determining a percent value for each of the plurality of strata relative to a value of the product inventory; and
estimating the number of counts to be performed for each strata based on the percent value associated with each strata.

8. The method of claim 1, wherein the at least one aspect includes one of a price, a type, a size, or a storage characteristic associated with the plurality of products.

9. The method of claim 1, wherein the at least one aspect includes a price associated with the plurality of products.

10. The method of claim 1, wherein the at least one aspect includes a part number associated with the plurality of products.

11. The method of claim 1, wherein the at least one aspect includes a size associated with the plurality of products.

12. The method of claim 1, wherein the at least one aspect includes a storage characteristic associated with the plurality of products.

13. The method of claim 1, wherein the inventory error includes a difference in monetary value between the inventory record and a value of the inventory associated with the statistical test count data.

14. The method of claim 1, wherein the inventory error includes a difference between the inventory data associated with the statistical test count and data contained in the inventory record.

15. The method of claim 1, wherein the predetermined error threshold includes a historical inventory error average associated with previous statistical test count performances.

16. The method of claim 1, further including adjusting the predetermined criteria associated with the sample size so as to reduce the sample size, if the inventory error is less than a minimum threshold.

17. A computer readable medium for use on a computer system, the computer readable medium including computer executable instructions for performing a method comprising:
selecting a product population associated with a product inventory;
grouping the product population into a plurality of strata, each strata having a plurality of products, each product including at least one aspect common to each of the other products of the plurality of products;
determining a sample size for each of the plurality of strata associated with a statistical test count process based on a predetermined criteria;
performing a statistical test count of each strata, based on the determined sample size;
determining an inventory error based on the statistical test count;
comparing the inventory error with a predetermined error threshold;
adjusting, based on historical inventory error data, the predetermined criteria associated with the sample size if the inventory error exceeds the predetermined error threshold; and
updating an inventory record associated with the product inventory if the inventory error does not exceed the predetermined error threshold.

18. The computer readable medium of claim 17, wherein the predetermined criteria includes a desired confidence factor associated with the statistical test count.

19. The computer readable medium of claim 18, wherein determining the sample size for each of the plurality of strata includes adjusting the desired confidence factor based on historical accuracy data associated with the statistical test count.

20. The computer readable medium of claim 19, wherein the historical accuracy data includes a standard deviation associated with the performance of previous statistical test counts.

21. The computer readable medium of claim 20, wherein determining the sample size for each of the plurality of strata includes estimating a minimum number of samples using the equation:
$$n = {( \frac{x}{Δ} )}^{2} \cdot P ( 1 - P )$$
where x is a predetermined constant corresponding to the desired confidence factor, P corresponds to the desired confidence factor, and Δ includes an average standard deviation based on historical statistical test count data.

22. The computer readable medium of claim 17, wherein performing a statistical test count includes determining, based on the sample size, a number of physical counts to be performed as part of a statistical test count associated with each strata.

23. The computer readable medium of claim 22, wherein determining the number of counts to be performed for each strata includes:
determining a percent value for each of the plurality of strata relative to a value of the product inventory; and
estimating the number of counts to be performed for each strata based on the percent value associated with each strata.
